(19) United States
(12) Patent Application Publication
(10) Pub. No.: US 2007/0171766 A1
(43) Pub. Date: Jul. 26, 2007

(54) Device for kneading, slowly fermenting and producing sourdough

(76) Inventor: Michel Loiselet, Montjaux (FR)

Correspondence Address: GREENBLUM & BERNSTEIN, P.L.C., 1950 ROLAND CLARKE PLACE, RESTON, VA, 20191, US

(21) Appl. No.: 11/569,660

(22) PCT Filed: May 27, 2005
(86) PCT No.: PCT/FR05/01305

§ 371 Date: Nov. 27, 2006

(30) Foreign Application Priority Data
May 28, 2004 (FR) 0405776
Mar. 29, 2005 (FR) 0503005

(51) Int. Cl. A21C 1/06; A21C 1/14

(52) U.S. Cl. 366/92; 366/97; 366/185

(57) ABSTRACT

The invention relates to a system of devices for kneading, mixing and fermenting viscoelastic dough comprising a swing tank (10) provided with a driven arm (30) and a helicoidal counter-arm (31) which is driven by a dough mixture flow and associated to a weakly stirring air-conditioning device producing and maintaining a constant temperature of air and dough pieces ranging from 20 to 26° C. during kneading, tempering and storing and corresponding to an accelerated fermentation and from 9 to 16° C. which makes it possible to carry out slow growth of the dough pieces and to produce sourdough corresponding to a second slow fermentation stage.

### TECHNICAL FIELD

The present invention relates to the field of kneading, slow fermenting of puff pastry dough requiring storage, and production of sourdoughs and visco-elastic dough at controlled/regulated temperatures and moisture levels, particularly for craft bakers, semi-industrial producers, small, medium and large businesses, laboratories, particularly in the milling industry, makers of sweetened dough products, rusk makers, brioche makers, biscuit makers and certain agricultural and food industries where the aim is to achieve the development of flavor, regularity and better keeping quality, by economical remodeling of existing bakeries which are generally limited in area, and the creation of new types of bakeries, laboratories and biotechnology production sites.

It relates in particular to horizontal and vertical mixing kneaders having tipping bowls for discharging the dough and collecting it in a movable vat or a weigher.

It also proposes improvements to air-conditioning devices with low air mixing associated with regulated and controlled heating and humidifying systems for the fermenting of stored puff pastry dough, combined directly or indirectly with horizontal, oblique, spiral and kneading arm fermenting kneaders for breadmaking and other industries, and with banks of miniature laboratory kneaders for the production of dough and sourdough.

### PRIOR ART

At present, dough and puff pastry dough is fermented outside the kneaders in fermenting and cooling chambers with programmable and controllable temperature and hydration, which can be set to provide controlled keeping and raising power of stored puff pastry dough and sometimes of sourdough in bulk. However, these devices are cumbersome and costly.

There are known kneading devices with horizontal tipping bowls comprising a single rotating arm with two inverted helical branches (known as a “single Z” kneader) used in the biscuit making industry to form a fairly stiff dense dough, as well as the horizontal mixing kneader with two tools and two branches with counter-rotating movements (known as “double Z”) providing high fiber shearing, rather unsuitable for very fragile breadmaking dough, as well as the vertical type of kneader with a fixed bowl, also with counter-rotating tool movements, such as those described in FR-A-0240842.

There are also known mixer kneaders and fermenting reaction kneaders of the horizontal, fixed bowl type with one rotating tool and one fixed tool, such as those described in FR-A-2710551, PCT WO 00/51438 and FR-A-2759863.

It is known that horizontal fermenting reaction kneaders, such as those described in PCT WO 00/51438, also permit dough kneading at approximately 24° in short periods and sourdough making after kneading at approximately 13° over long periods (during staff rest times), based on a cooling system connected to a double insulated wall bowl of the fermenting reaction kneader: this is a relatively costly special unit which is activated in cycles according to the temperature deviations of the sourdough (8/14°) and which activates the temperature deviations of the sourdough (8/14°) and which also activates the slow rotation of the rotating arm as a cooling cycle.

There are also other known types of mixer kneaders with rotating bowls with vertical or oblique axis, generally operating in only a third of the volume of dough in a renewed stream in a fixed bowl or a trolley-mounted pull-out bowl such as those described in FR-A-519267 and EP-0354190.

It is known that mixer kneaders with a single tool rotating concentrically in a fixed bowl have a very limited mixing and kneading range in terms of visco-elasticity of the dough, and that, on the other hand, the rotating tool commonly causes the rotation of the body of dough, thus limiting the kneading action and also leading to a modification of the operating time or, more frequently, a variation in the quality of the results.

It is also known that mixer kneaders with two counter-rotating tools or a rotating tool and a fixed tool in a bowl tend to tear the fibers of breadmaking dough, in spite of their mixing efficiency.

### OBJECT OF THE INVENTION

The invention relates to improvements to these devices for the purpose of improving their operation and efficiency in bakeries and enabling bakeries to be remodeled at lower cost.

The invention relates to a fermenting mixer kneader of the type comprising a tool rotating in a fixed bowl which tips to discharge the dough into a movable vat which is collected by an elevator, or more directly the elevation of the fermenting mixer kneader above the hopper of a volumetric weigher, characterized in that it has, in addition to the rotating tool driven by a high-torque transmission, a second freely rotating tool driven by the stream of dough at a lower speed regulated by a brake so as to provide kneading with counter-rotating movements to protect the fibers.

The invention also relates to an air-conditioning system with low air mixing with heating or cooling to prevent the crusting of the puff pastry dough, with a controllable and programmable humidifier, associated directly or indirectly with fermenting kneaders which are for example, but not exclusively, of the horizontal, oblique or spiral type.

According to the invention, the regulation of the speed differential by the brake has an effect on the kneading which can be determined by the user. It also provides a flexibility of operation for doughs having visco-elastic consistencies varying widely according to the flours used and the percentage of water, which can vary about a base of 60% from 48% to 80% of the weight of the dry substances. The incorporation of a freely rotating counter-arm simply driven by the stream of dough at a slower speed than that of the powered arm rotating in a correlated way preserves the fibers of the dough. The economical regulation of the rotation speed of the counter-arm, and therefore of the intensity of the mixing and kneading, by means of a brake which is more economical than a second transmission, improves the results and provides a wider range of use.

Furthermore, at a time when the breadmaking industry is moving toward methods of slow fermentation at 8° to 16° during, and in accordance with, staff rest times ranging from 12 to 48 hours, for day working, and in order to provide hot bread all day long with better flavor, it has been found that the diffusion air-conditioning systems which have been developed for the winemaking industry (a form of biotechnology having similarities with that of breadmaking dough) can cool a dough preparation room housing the fermenting mixer kneader or kneaders, and can easily be used (by limiting the volume of fermenting chambers) for making sourdough, where it is simply necessary to activate, after kneading, either in programmable cycles (for example one minute every thirty minutes), using the programmer of the control panel for programming slow rotation cycles, based solely on time and not on the temperature differences of the sourdough, or continuously and with an extremely slow rotation speed (with the brake released), in order to activate the fragile fibers and introduce air to reactivate the fermenting process and thus prevent the degradation of sourdough which becomes too acid, while supporting the development of flavor.

According to another characteristic of the invention, the interior of the bowl, made from steel for example, is provided, by a manufacturing process known as “rotary molding”, with a thick coating of food-grade non-stick PEHD material to facilitate the discharge of the sticky dough, said coating not requiring the use of stainless steel which has to be polished. The bowl can advantageously be designed with fillets in the corners to facilitate its cleaning, with a plastic boom, and can have a spout higher than the bowl to facilitate the discharge of the body of dough, particularly when the bowel is tipped above the hopper of a weigher, in order to be in the ideal position.

According to another characteristic of the invention, the double-walled wheeled dough collecting vat is provided with a food-grade non-stick coating, made of PEHD for example, using a process known as “rotary molding”.

According to another characteristic of the invention, each end of the branch of each arm is provided with a shape which can push the dough stream back toward the center of the bowl in the single direction of counter-rotating rotation.

According to another characteristic of the invention, the powered arm has an S-shaped helical branch promoting the orientation of the dough stream toward the center of the bowl on each side of the arm, the helicoid angle being about 160/195° and not outside this range, in order to provide, using a sensor, positioned stops of the branch of the arm in the high position to facilitate the emptying of the bowl when it is tipped.

According to another characteristic of the invention, the freely rotating arm, known as the counter-arm, and the powered arm have, at the inverse ends on the securing and guiding ends, progressive cross sections of their respective branches which are much larger on the attachment ends and smaller on the guiding ends.

According to another characteristic of the invention, the arms, made for example from food-grade light alloy castings, are provided with reinforcing inserts at their end attachments, made from bronze or non-stick stainless steel for example, to replace if necessary the positioning of non-stick rings, ensuring the rotation of the arms at the guiding ends and supporting the pressure of the securing elements on the driving end, and additionally to avoid or facilitate finishing machining after casting.

According to another characteristic of the invention, the brake unit is preferably composed of a regulating knob fixed to a threaded shaft, preferably inclined, passing through a tapped bushing, which itself is fixed to one of the two flanges of the frame connecting, at the end of the machined threaded shaft passing through a self-lubricating ring, the lining holder and the lining which bears on the hub of the shaft of the counter-arm, any other braking means being equally feasible.

According to another characteristic of the invention, the bowl is preferably tipped by means of an inflated pneumatic wheel bearing on the outer wall of the bowl, said pneumatic wheel being driven preferably by a compact geared motor with a high reduction ratio, of the two-stage cycloid type or of the planetary type with three gear trains, bolted to the frame.

According to another characteristic of the invention, the two feet of the frame, preferably made from rectangular tube, are positioned outside the two side members of the frame, in order to leave the maximum space free for the movable dough receiving vat, while limiting the width of the side members.

According to another characteristic of the invention, the two lateral covers, which are heat-formed for example, covering the thick side members, are pivoted on hinges, one of the covers incorporating, in the upper inclined part, the control box of the fermenting mixer kneader.

According to another characteristic of the invention, a liftable safety screen incorporates a water inlet unit composed of flexible connectors, a valve or solenoid valve, a flow meter and two special nozzles to promote the atomized water and air mixture which is important for the mixing stage and consequently for the development of flavor during fermenting.

According to another characteristic of the invention, the double PEHD wall of the movable vat is filled with insulating foam, while the material of said movable vat produced by rotary molding surrounds the lower metal chassis onto which is pressed a sliding hatch which, in the open position, is completely incorporated in the lower shape of the movable vat on the handle side, the metal chassis of said movable vat being made from hollow rectangular tube positioned in the lower part of the movable vat to allow the positioning of the two forks of an electrical stacking truck for distribution in its lowest possible position before elevation above a weigher hopper or above a high table of a dividing head.

According to another characteristic of the invention, the sliding hatch of the movable vat is guided by a distribution unit comprising two guides, four sleeves, a drive screw, a threaded sleeve and a handwheel which can be replaced by a small motor in a version in which the hatch is automatically opened/closed and activated for the complete discharge of the dough into the weigher hopper.

According to another characteristic of the invention, the movable vat is replaced, in a fully automatic version, by an elevating distribution table equipped, for example, with rollers on rails which can move the fermenting mixer kneader horizontally before the dough is tipped directly into a hopper of a volumetric weigher with a control panel.

According to another characteristic of the invention, the sliding hatch of the movable vat is guided by a distribution unit comprising two guides, four sleeves, a drive screw, a threaded sleeve and a handwheel which can be replaced by a small motor in a version in which the hatch is automatically closed and opened, activated for the complete discharge of the dough into the weigher hopper.

According to another characteristic of the invention, the movable vat is replaced, in a fully automatic version, by an elevating distribution table equipped, for example, with rollers on rails which can move the fermenting mixer kneader horizontally before the dough is tipped directly into a hopper of a volumetric weigher with an independent control panel. The elevation and movement of the elevating table which is preferably hydraulic, and the tipping of the bowl provided with a spout are carried out either by a geared motor, or by an electrical or electro-hydraulic jack, or, more economically, by a pneumatic actuator supplied from a compressed air network which is usually available in an industrial or semi-industrial enterprise.

According to another characteristic of the invention, a temperature sensor is advantageously positioned on the side of the lower part of the tipping bowl, and is connected by a flexible insulated cable to the display of the control panel, as is the electrical cable of the water flow meter of the measured supply screen.

According to a first improvement of the invention, the fermenting kneaders are provided with a panel for programming/regulating the kneading during the working time of the bakers and the sourdough production cycles during their rest periods, while combining the programs with the regulation of the air temperature by means of a controller incorporated into each type of kneader.

According to another improvement made to horizontal fermenting kneaders for breadmaking, the shape of the braked counter-arm blade is spiral, to ensure more constant penetration into the dough and more uniform speed regardless off its position in the rotation in the bowl.

According to another improvement made to horizontal fermenting kneaders for breadmaking, the bowl is tipped by a compact geared motor and brake unit of a cycloid or planetary type, which uses rollers to drive a belt fixed to the bowl, enabling the bowl to be tipped for discharge and raised again with better integration.

According to another improvement made to horizontal fermenting kneaders for breadmaking, the water inlet, its solenoid valve and its flow sensor are fixed, preferably but not exclusively to one of the two thick side members with a rosary connector on the safety screen which also provides the water inlet to two special atomizing nozzles promoting the water/flour/air combination.

According to another improvement made to horizontal fermenting kneaders for breadmaking, an electrical control box containing the electrical components and the frequency controller is incorporated on the transmission side and fixed to the side member.

According to another improvement made to oblique and spiral fermenting kneaders for breadmaking, a transmission unit which is extremely compact because of the implementation of a high efficiency planetary type geared motor such as those used in particular in construction site machinery requiring a high radial capacity is adapted without reinforcement to the driving of kneading arms. This transmission unit is installed on a thick vertical pivoted support plate connected to a hollow column made for example, but not exclusively, from very thick square or rectangular tube.

According to another improvement made to oblique and spiral fermenting kneaders for breadmaking, the arm transmission support plate is connected to and pivoted on a column in the upper part of the equipment which incorporates the bushings, an auxiliary gas actuator and an indexing pin which locks the head unit in the kneading position by fitting into a thick part which itself is connected to the pivot.

According to another improvement made to oblique and spiral fermenting kneaders for breadmaking, the unit consisting of a shoe brake or regulated by a compact cycloid or planetary geared motor acts by means of a single roller coated with a flexible material bearing on the outer periphery of the rotating bowls.

According to another improvement made to banks of horizontal, oblique and spiral fermenting kneaders, a single geared motor drives all the arms at the same speed, for example, but not exclusively, by means of pulleys and toothed belts, the very high precision between the different kneaders being specified particularly for each type of bank, the mechanism being fully incorporated into a beam made from tube of square or rectangular section.

According to another improvement made to banks of horizontal, oblique and spiral fermenting kneaders for laboratories, a single geared motor drives the bowls, for oblique and spiral kneaders, and the counter arms, for horizontal kneaders, to provide a high precision between the kneaders, the whole system being incorporated into a beam for each type of bank.

According to another improvement made to banks of small oblique or spiral breadmaking fermenting kneaders, the beam unit including the different arms is liftable, with the assistance of a gas actuator. In horizontal kneaders, only the screens are liftable.

According to another improvement made to small oblique or spiral breadmaking kneaders with a bowl capacity of up to one hundred and twenty liters, two beams of square or rectangular section made from thick tube or by mechanical welding are used for each machine, with bushings, toothed belt or chain connected to a compact geared motor unit, while the liftable upper beam unit is retained.

### DESCRIPTION OF THE DRAWINGS

FIG. 1 is a schematic view of one side of the fermenting mixer kneader according to the invention, showing the brake device of the freely rotating arm.

FIG. 2 is a view of the other side of the fermenting mixer kneader in question, showing the powered arm transmission device.

FIG. 3 is a side view in section of the horizontal fermenting mixer kneader.

FIG. 4 is a front view of the fermenting mixer kneader from the cover and control panel side.

FIG. 5 shows schematically the elevating table unit of the fermenting mixer kneader.

FIG. 6 shows a weigher seen from above, with its hopper.

FIG. 7 is a detail view in section from the side of the transmission of the fermenting mixer kneader.

FIG. 8 is a detail view in section from the side of the brake device included in the fermenting mixer kneader.

FIG. 9 shows the shapes of the powered arm and the freely rotating counter-arm of the fermenting mixer kneader.

FIG. 10 is a front view in section of the fermenting mixer kneader.

FIG. 11 shows the display screen of the electrical controls of the fermenting mixer kneader.

FIG. 12 shows the detail of the sliding hatch of a movable vat.

FIGS. 13, 14 and 15 are perspective views of a horizontal breadmaking fermenting kneader showing its internal details in a see-through view.

FIG. 16 in a perspective detail view of the drive device of the power arm of the kneader shown in FIG. 13.

FIG. 17 is a perspective detail view of the device for tipping the bowl of the kneader shown in FIG. 13.

FIG. 18 is a perspective view of a spiral fermenting kneader showing the transmission unit in a see-through view.

FIG. 19 is a perspective view of the detail of the transmission unit of the kneader shown in FIG. 18.

FIG. 20 is a perspective view of an oblique fermenting kneader.

FIG. 21 is a perspective view of an oblique fermenting kneader.

FIGS. 22 and 23 are perspective views of a group of small fermenting kneaders, oblique in FIG. 22 and spiral in FIG. 23.

### DESCRIPTION OF THE PREFERRED EMBODIMENTS OF THE INVENTION

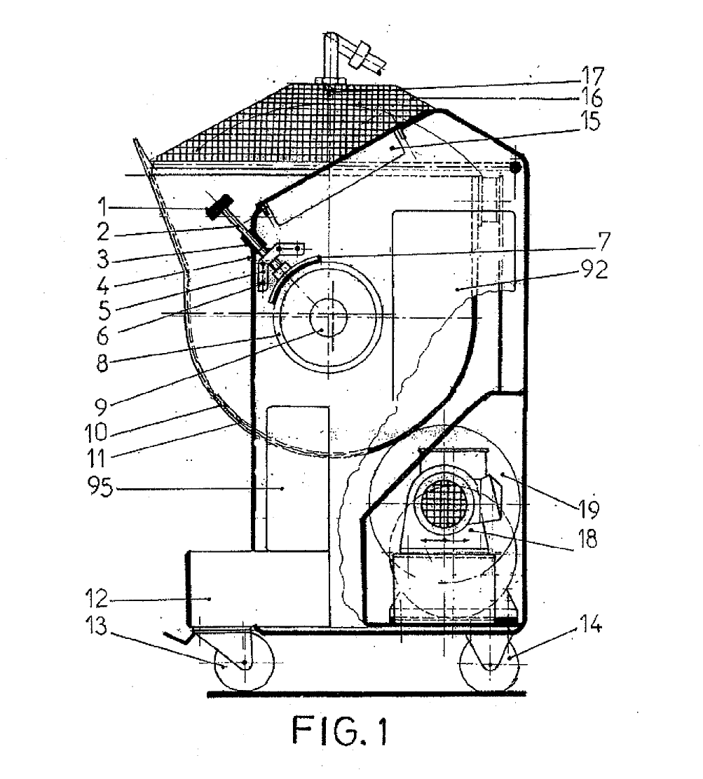

As shown in FIG. 1, the set of devices forming the brake comprises a regulating knob 1, a threaded shaft 2, a protection ring 3 incorporated in the side cover, a threaded bushing 5 fixed to one of the sides 6, a lining holder 7, a hub 8 fixed to the shaft 9 of the counter-arm, a steel bowl 10 with its rotary molded coating 11, two feet 12 of the frame, two brake castors 13, two fixed castors 14, the control box unit 15 incorporated in the side cover 4, a liftable safety screen 16 and the partial water inlet to one of the two nozzles 17 fixed to the safety screen, a geared motor 18 and the pneumatic wheel 19 for tipping the bowl 10.

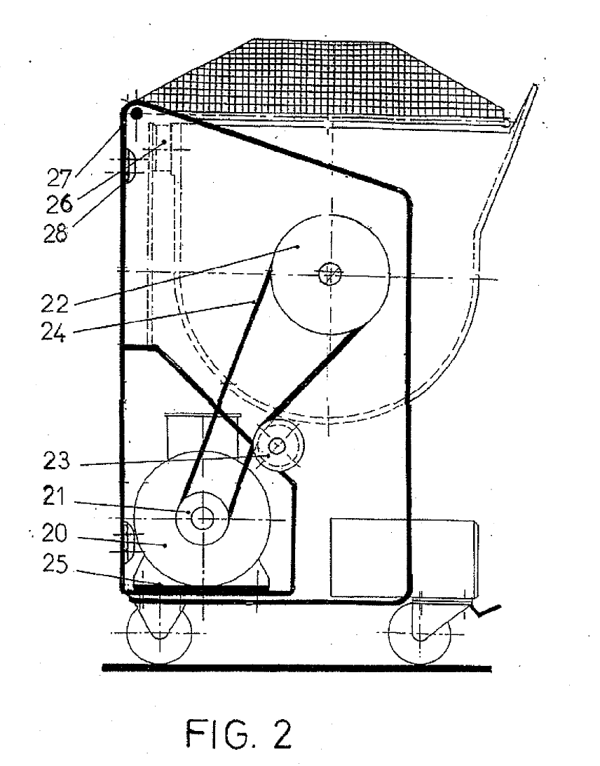

As shown in FIG. 2, the set of transmission devices for the powered tool 30 includes a brake motor 20, a driving pulley 21, a reducing pulley 22, a tensioning roller system 23, a belt 24, an anti-vibration mat 25, two bowl dampers 26, a side cover 27 and, by way of example, two hinges 28.

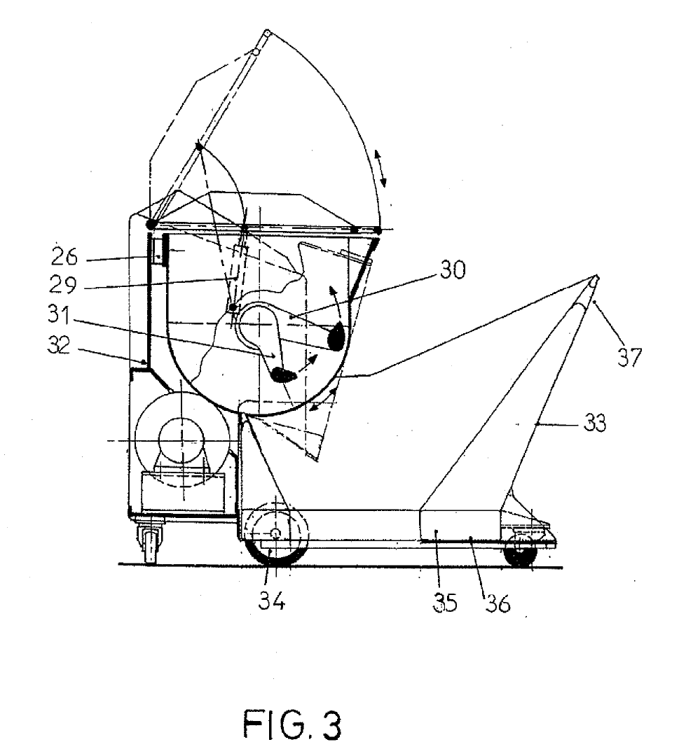

The small horizontal fermenting mixer kneader shown in FIG. 3 comprises the steel bowl, coated with a food grade non-stick material, of a liftable screen equipped with two auxiliary gas actuators 29, a powered arm 30, a counter-arm 31, a bowl damper 26, a frame 32, a movable vat 33 on castors 34 with its chassis 35, its hatch 36 and its handles 37.

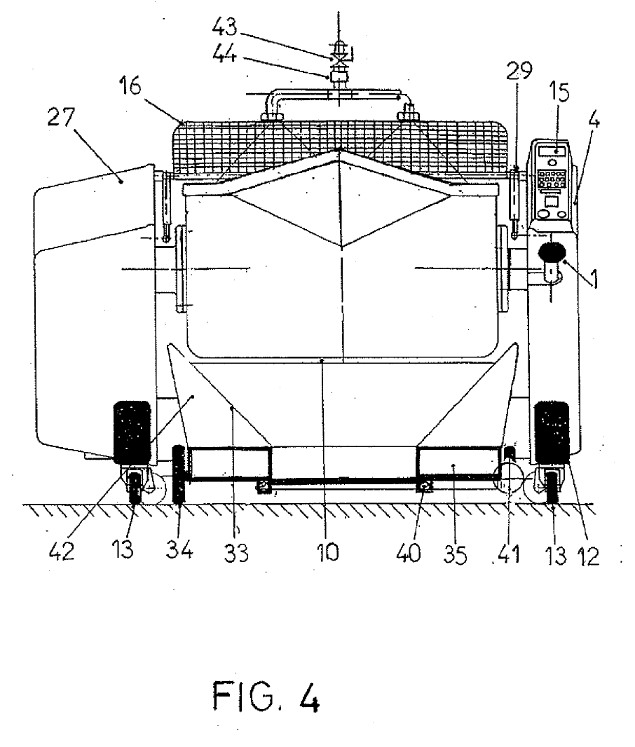

The set of devices shown in FIG. 4 in a front view comprises a side transmission cover 27, a side control cover 4, two feet of the frame 12, a control panel 15, a brake control knob 1, two braked castors 13 of the frame, the liftable screen 16, the bowl 10, the movable vat 33, the hatch guides 40, a hatch operating handwheel 41, a movable vat chassis 35, insulating foam 42, castors 34, a quarter turn valve 43 and a flow meter 44.

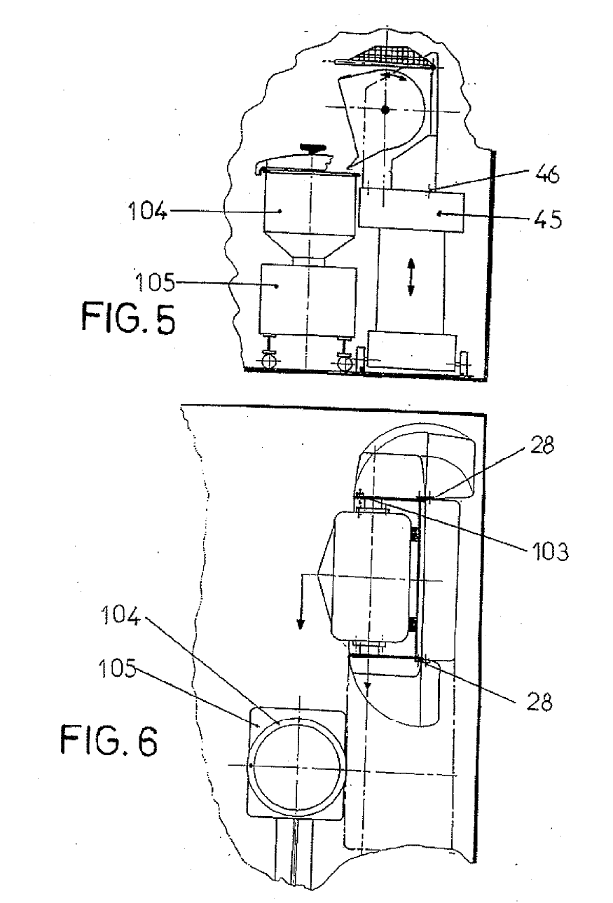

As shown in FIG. 5, the fermenting mixer kneader is located above the hopper 104 of a volumetric weigher before the tipping of the bowl equipped with a spout for the direct discharge of the body of dough, said kneader being bolted to the platform 46 of a horizontally sliding elevating table 45.

This unit is shown in FIG. 6 in a view from above, which shows the weigher 105 with its hopper 104 and the kneader with a safety sensor 103 and the hinges 28.

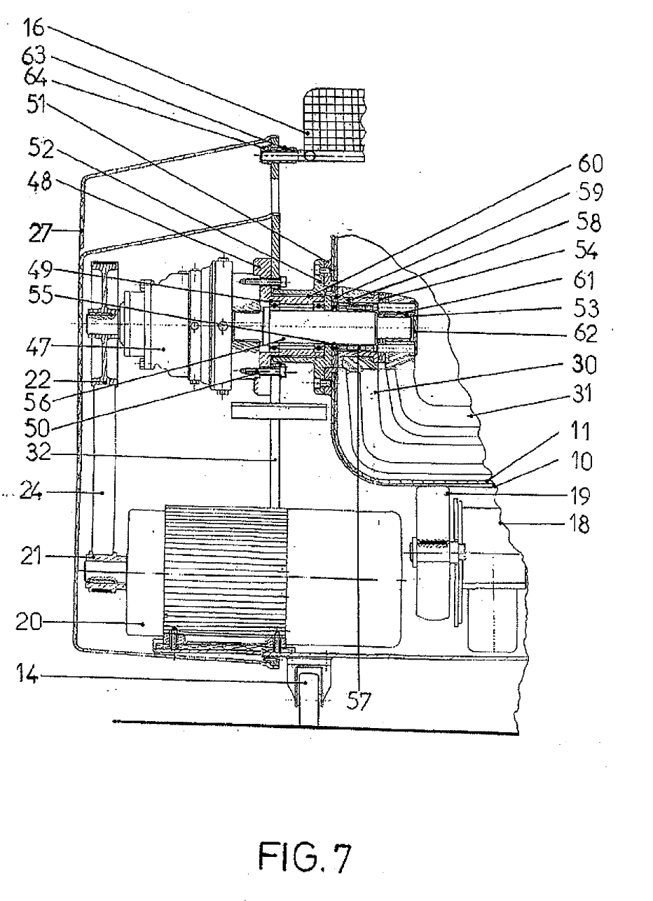

The transmission means shown in FIG. 7 comprise, under a side cover 27, a tipping geared motor 18, a pneumatic wheel 19, the steel bowl 10 and its coating 11, the powered arm 30, the counter-arm 31, a brake motor 20, a driving pulley 21, a belt 24, a reducing pulley 22, a planetary reduction unit 47, a reduction unit flange 48 holding roller bearings 49 directly fixed to the reduction unit and to the frame by screws 50, a bowl flange 51, a bowl counter-flange 52, a self-lubricating ring 53 and 54, a shaft joint 55, a transmission shaft 56 grooved at one end, a securing element 57, a powered arm insert 58, a self-lubricating washer 59, a self-lubricating guide bush 60, a counter-arm insert 61, a plug 62, a screen ring 63, a screen nut 64, a screen 16, a fixed frame castor 14 and a frame 32.

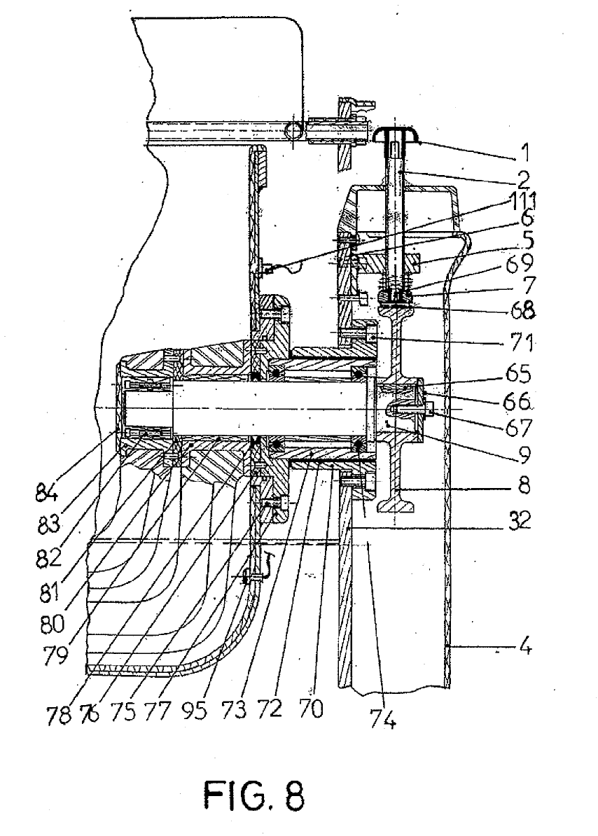

On the electrical control side, the brake system shown in FIG. 8 comprises the side cover 4, the brake hub 8 fixed to the shaft 9 of the counter-arm by a key 65 and retained laterally by a washer 66, a screw 67, a lining 68 bonded to the lining holder 7 in which the machined threaded shaft 2 is retained by a washer and a countersunk screw 69, a self-lubricating guide bush allowing the rotation of the threaded shaft passing through the tapped bushing 5 fixed to the side 6 of the frame 32 and connected to the brake control knob 1, a flange 70 fixed by screws 71 to the side member of the frame in which flange is placed a self-lubricating guide bush 72 which holds a sleeve 73 and two bushings 74, a bowl flange 77 fixed to the bowl by screws 75, a self-lubricating washer 76, a joint 78, a self-lubricating ring 79, an insert 80, a self-lubricating ring 81, a securing element 82, an insert 83, a cover 84 on the counter-arm and, at a preferred location on the wall of the bowl, a temperature sensor 95 and a position sensor 111.

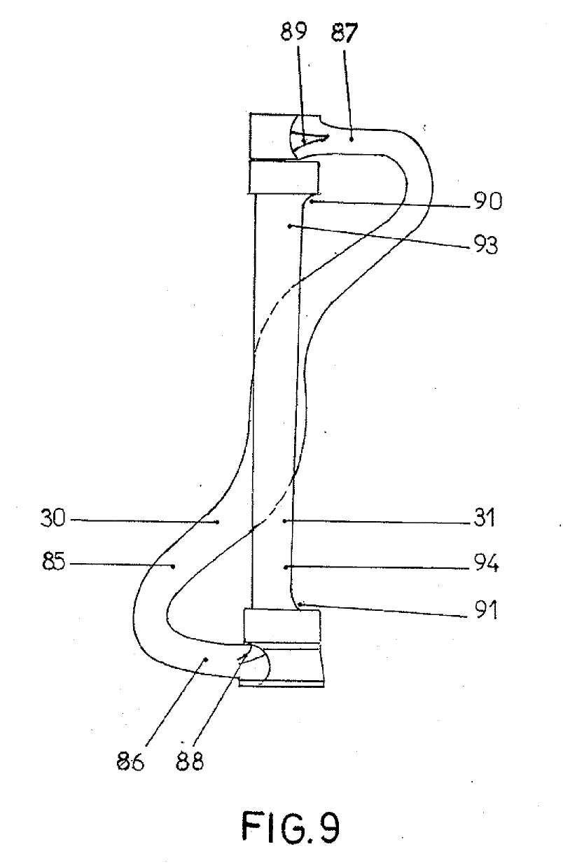

FIG. 9 shows the drawings of the powered arm and the counter-arm which are in the form of a helical “S” 85 with progressive cross sections 86 and 87, together with the end shapes 88 and 89 of the powered arm 30 and the end shapes 90 and 91 and the branches with progressive cross sections 93 and 94 of the counter-arm 31.

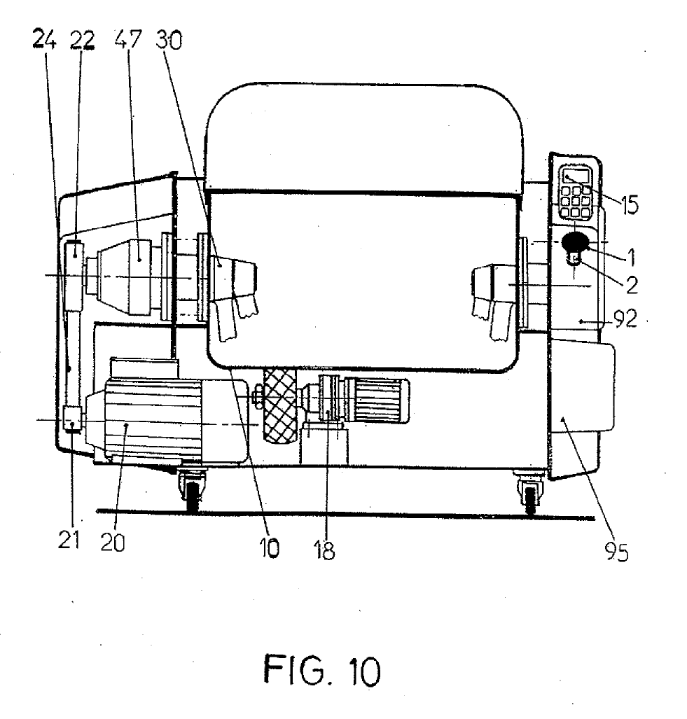

The set of devices shown in FIG. 10 comprises the powered arm 30 driven by the planetary reduction unit 47, the pulley 22, the belt 24, the driving pulley 21 and the brake motor 20. The other geared motor 18 equipped with a pneumatic wheel serves to tip the bowl 10 to empty it. The brake knob 1, the threaded shaft 2, the control box for display 15 and programming, a box containing the other electrical components 92, and a frequency-based speed controller 95 of one of the variants of the mixer kneader are located on one of the side covers.

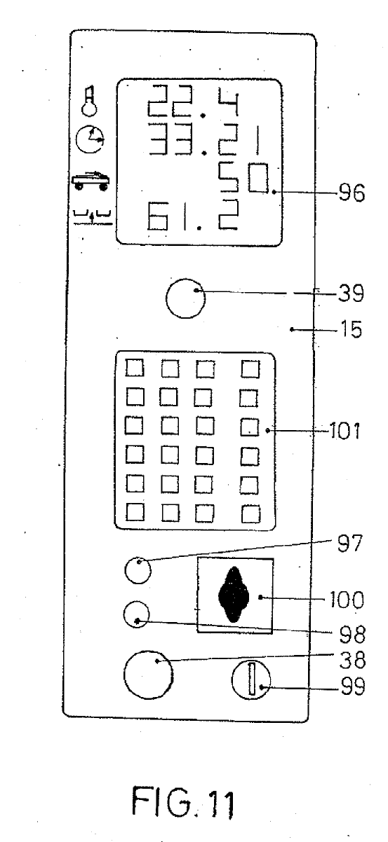

The set of devices shown in FIG. 11 comprises a display screen 96 having a plurality of lines, namely one for the water flow in kg, one for upward or downward time counting, one for the temperature of the dough, and one for speed, a mushroom head safety button 38, a potentiometer button 39, two start/stop buttons 97 and 90, a retaining button 99 for tipping the bowl, a power switch 100, and a membrane keypad 101 for programming with dished keys.

An electrical distribution stacker for lifting the movable vats completes the equipment.

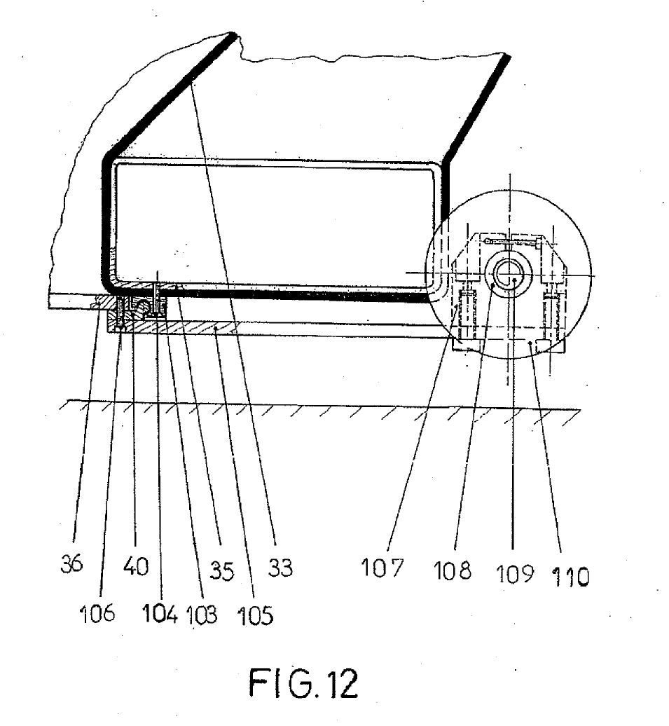

As shown in FIG. 12, the movable vat 33 is equipped with the hatch 36 which is positioned under its chassis 35 and which is moved by a handwheel 110 by means of one of the two guides 40, one of the two guide supports 103 fixed to the chassis by screws 104, a counter-plate 105 connected on one side to the guide and to the hatch by two screws 106 and on the other side to one of the two flanges 107 supporting one of the two nuts 108 of a screw 109 fixed to one of the two sides of the chassis.

The devices which have been described relate in particular to horizontal fermenting mixer kneaders with combinations of tools with counter-rotating movements, preferably regulated by a brake with respect to the speed differential and the intensity of relative forces in a bowl coated with a thick rotary molded food-grade non-stick material to facilitate, when the bowl is tipped, the complete discharge of the body of dough into one of the movable vats made from rotary molded food-grade non-stick material which is subsequently collected by a simple distribution elevator for discharge either into the hopper of a volumetric weigher or onto a high table of a dividing head by the opening of the hatch of the vat. In this economical configuration, two to three movable vats can be used to store the bodies of dough for fifteen to forty minutes, a period favorable for the production of flavors and the rising power of the dough during fermenting phases, before the bodies of dough are divided into pieces of puff pastry dough.

In the automated version,, the horizontal fermenting mixer kneader is bolted directly to a hydraulic elevating table for distribution, equipped with rollers on rails to allow horizontal movement and the placing of the mixer kneader immediately above the hopper of a volumetric weigher before the bowl is tipped for the discharge of the whole body of dough, guided by the spout of the bowl.

The invention also relates to devices on vertical kneaders for pastry making, hotel, laboratory and domestic applications, with a smaller bowl volume but still having a powered tool and a freely rotating counter-tool whose speed is regulated by a brake.

The air conditioning system developed according to the invention has two main functions, namely that of producing and maintaining a constant temperature of the air and the puff pastry dough between 20′ and 26° during the bakers' working times, particularly for the purposes of kneading, rest times for the body of dough, division, relaxation time, shaping and storing puff pastry dough on wheeled racks, this phase corresponding to a first fermentation known as “fast” (daytime work), and that of reducing and maintaining the temperature of the air, the puff pastry dough and the sourdough in the range from 9° to 16° during the bakers' rest times, particularly to allow the slow rising of the puff pastry dough and the production of sourdough in interaction with the operation of the fermenting kneaders, this phase corresponding to a second fermentation known as “slow fermenting and sourdough production” (night work).

Also according to the invention, it is possible to apply two main types of air conditioning/reversible cooling units available on the construction and building installations market, these being, on the one hand, the advanced conventional units (technology developed for the winemaking industry) frequently used with diffusion ducts for balanced distribution of the air and with more slowly rotating fans, and, on the other hand, diffusion of conditioned air by means of a heat pump combined with a compressor unit with, for example, a conditioned air inlet above a new type of sealed flexible suspended ceiling incorporating lighting and diffusing the air gently at its periphery to cool or heat the bakery, via a gap of approximately twelve millimeters between the ceiling and the walls or partitions (such air conditioning suspended ceilings have been developed recently in the building installation industry and this method is particularly suitable for the remodeling of bakeries and for fitting new types of bakeries with networks of ducts equipped with hatches which can connect a number of rooms equipped with air conditioning suspended ceilings.

According to the invention, the control panels of horizontal, oblique and spiral fermenting kneaders for breadmaking, industry, and laboratory banks consist of two kneading programs (one based on the mixing and kneading times and the other based on the mixing time and the raising of the dough temperature during kneading), a bowl tipping program, a program for the solenoid valve and display of the water quantity, and a sourdough production program based on time to provide, in interaction with the action of the air conditioning, a decrease in temperature of the sourdough body being formed from approximately 24° to 12° at a slow rate (interaction of the sourdough mixing and the air temperature) and then subsequently by alternating cycles of slow rotation of the arms for approximately 1 minute every 40 minutes to produce a sourdough with a high aromatic quality (oxygenation+mechanical activity of the dough=stimulus to the fermenting process), these programs being connected to an automatic controller incorporated into each type of kneader (with combination of the programs and the air temperature regulation).

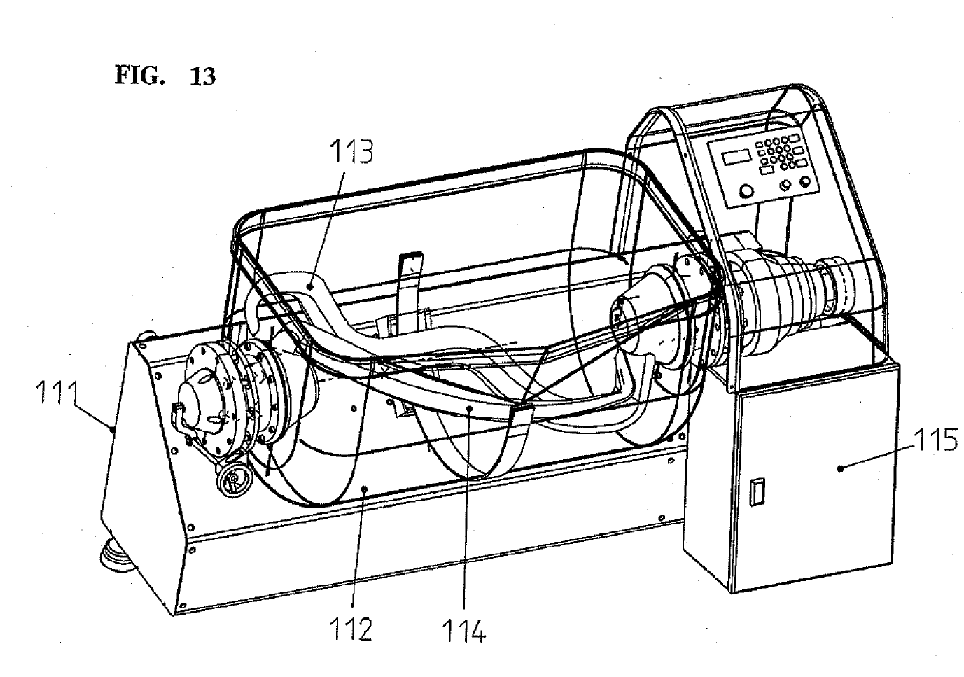

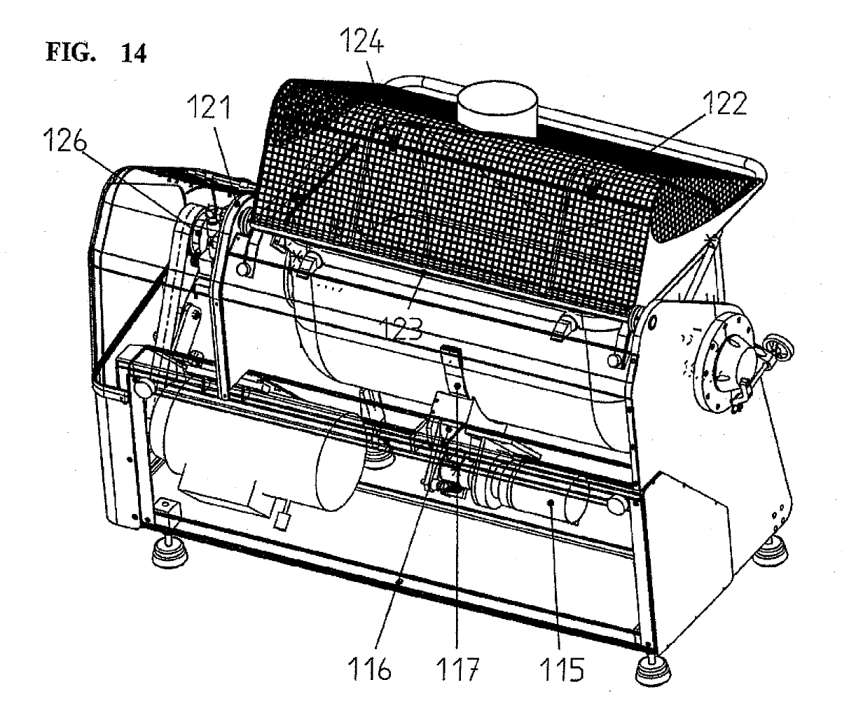

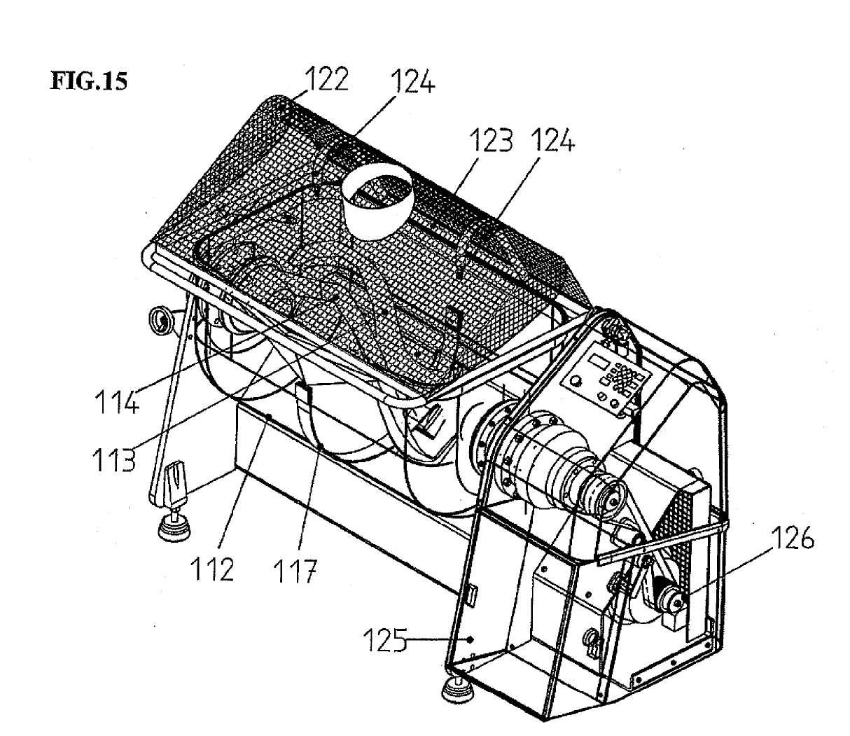

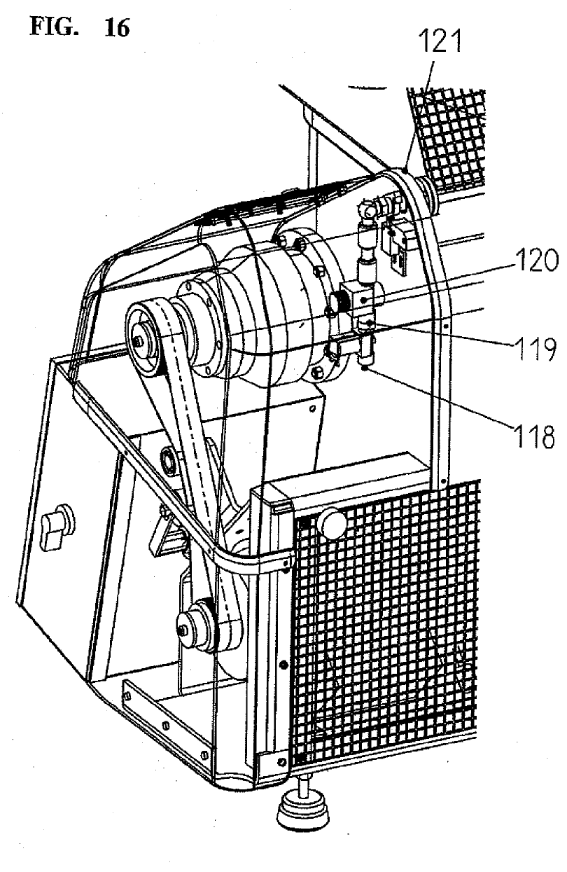

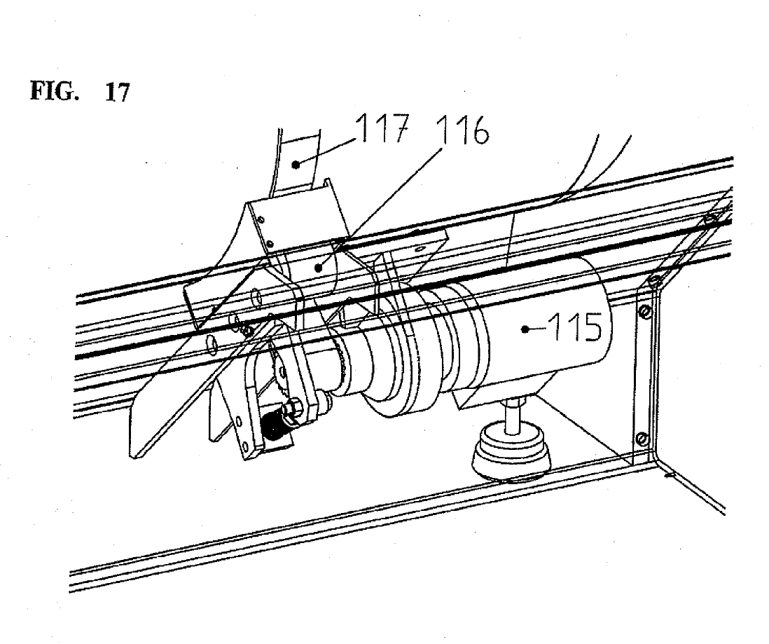

In FIGS. 13 to 15 which show a horizontal fermenting kneader for breadmaking, the reference 111 indicates the frame holding the bowl 112 in which the driving arm 113 rotates and in which the braked helical counter-arm 114 is located.

The bowl 112 is tipped by the compact cycloid or planetary geared brake motor 115 which drives, by means of rollers 116, the belt 117 fixed to the bowl.

The water inlet 118 with its solenoid valve 119 and its flow sensor 120 are fixed to one of the two thick side members 121 with a connector rotating on the safety screen 122 and supplies two atomizing nozzles 124 via a distributor 123.

The box 125 containing the electrical components and the frequency-based speed controller is incorporated in the transmission side 126 and fixed to the side member 121.

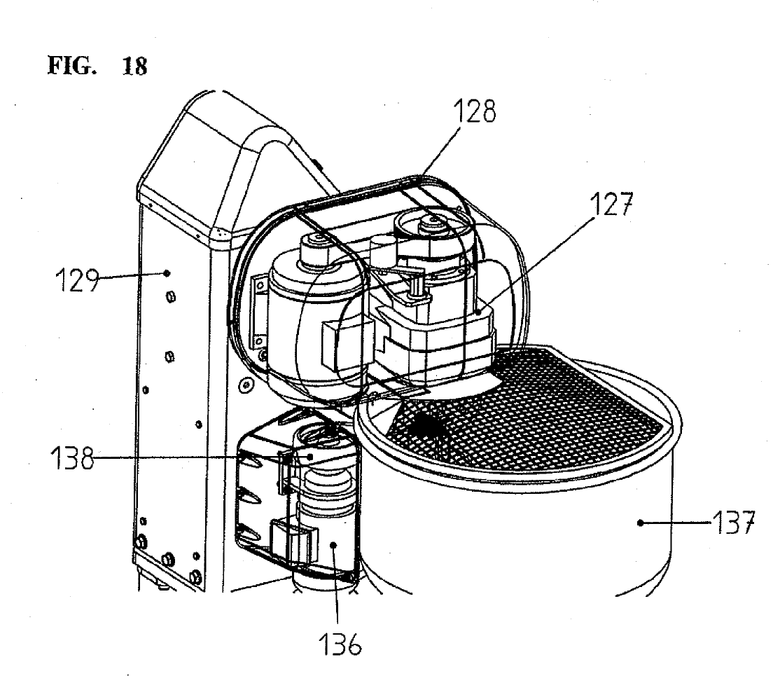

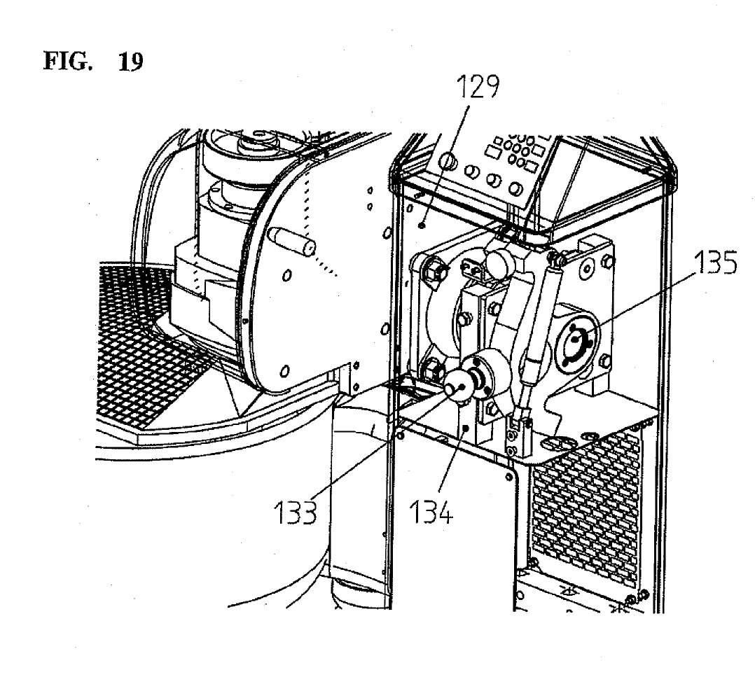

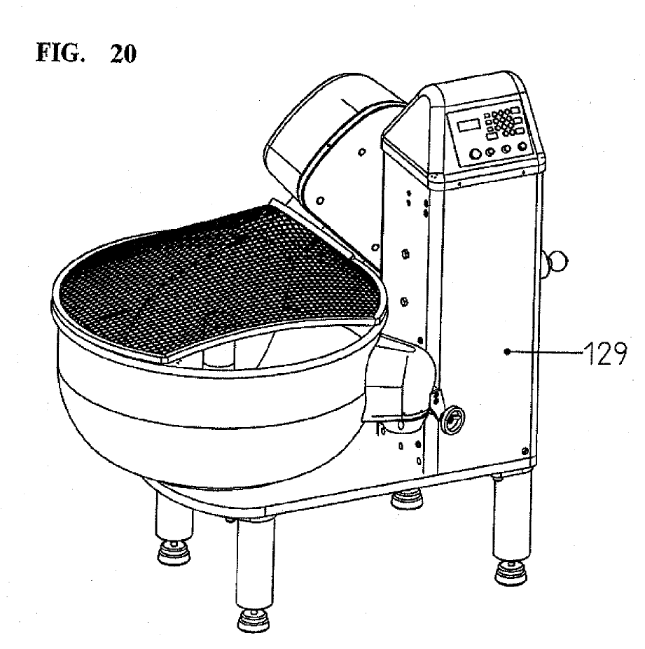

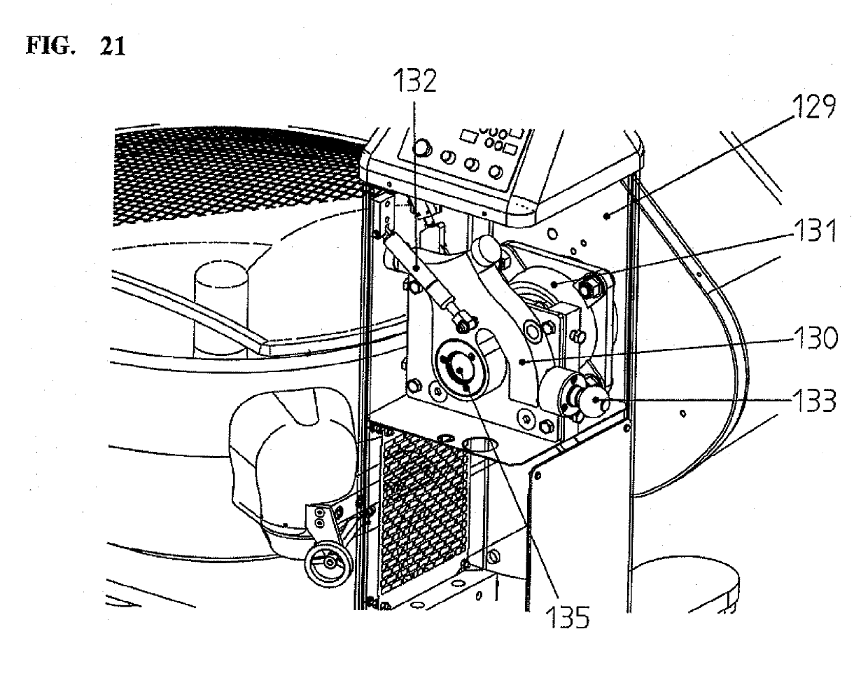

In the spiral fermenting kneader as shown in FIG. 18 and in the oblique fermenting kneader as shown in FIG. 20, the transmission means 127 are very compact because of the installation of a high-efficiency planetary reduction unit which is perfectly suitable for driving the kneading arm without reinforcement. The transmission unit is fixed to a thick hinged support plate 128 connected to a hollow column 129 made from thick tube.

The arm transmission support plate 130 is connected to and pivoted on the column 129 in the upper part which incorporates the bushings 131, an auxiliary gas actuator 132 and an index pin 133 which locks the assembly in the kneading position by fitting into a thick flange 134 which is itself connected to the pivot 135.

The unit consisting of a shoe brake 136 or regulated by a compact cycloid or planetary geared motor tips the bowl 137 by means of a roller 138 covered with a flexible material and bearing on the outer periphery of said bowl 137.

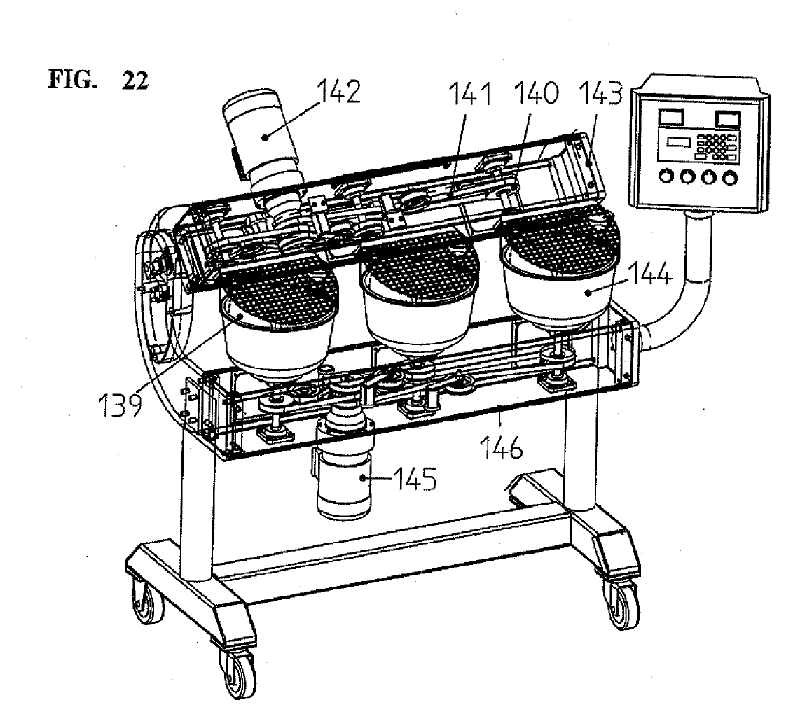

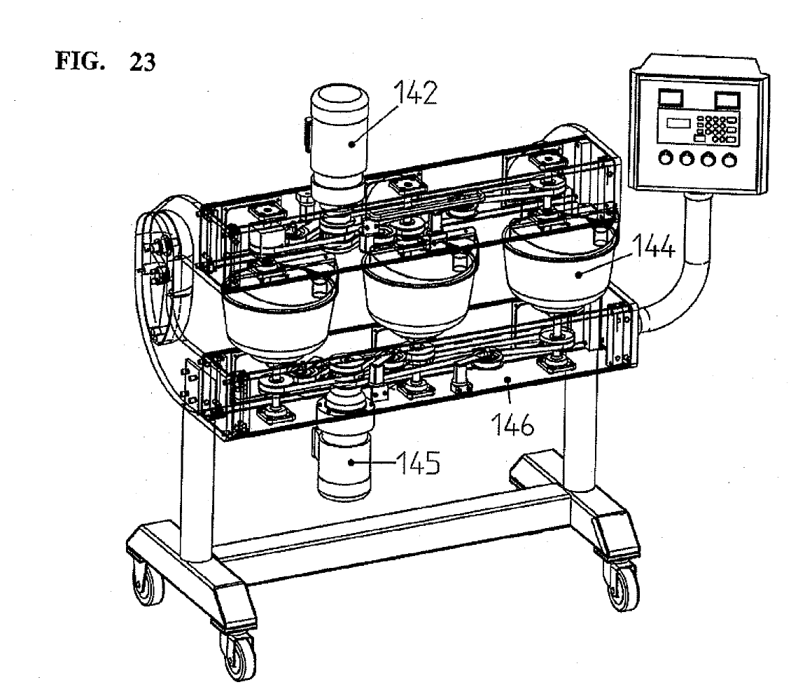

In banks of small oblique and spiral fermenting kneaders such as those shown in FIGS. 22 and 23, all the arms 139 are driven at the same speed, by means of pulleys 140 and toothed belts 141, by a single geared motor unit 142, the unit being incorporated into a beam 143 made from square or rectangular section tube.

In the banks of these small fermenting kneaders, the bowls 144 are all driven by a single geared motor unit 145 incorporated in a beam 146. In the banks of small horizontal fermenting kneaders, the counter-arms are also all driven by a single geared motor unit.

As shown in FIG. 22, in the banks of these small oblique and spiral fermenting kneaders, the beam unit 143 comprising the different arms 139 is liftable and assisted by a gas actuator.

1-36. (canceled)

37. A mixer kneader arrangement, the arrangement comprising:
a mixer kneader device for mixing and kneading dough comprising:
a driving arm adapted to rotate in a tipping bowl;
a transmission for driving the driving arm; and
a freely rotating counter-arm whose speed is regulated by a brake;
a movable vat arranged to receive dough discharged from the tipping bowl;
a hopper associated with a volumetric weigher; and
a device configured to elevate the mixer kneader device above the hopper.

38. The arrangement of claim 37, wherein the arrangement is capable of being placed in an air-conditioned dough preparation room and wherein the freely rotating counter-arm is driven by a dough stream at a lower speed than the driving arm.

39. The arrangement of claim 37, wherein the driving arm has a helical “S” shape which is configured to drive the dough stream toward a center of the tipping bowl.

40. The arrangement of claim 37, wherein the driving arm and the counter-arm have end shapes configured to drive the dough stream toward a center of the tipping bowl in a single direction of rotation.

41. The arrangement of claim 37, wherein the driving arm and the counter-arm have cross sections which are progressively larger at an attachment end and smaller at a guide end.

42. The arrangement of claim 37, wherein the driving arm and the counter-arm each comprise a food-grade light alloy casting that is reinforced at an attachment end and at a guide end by machined non-stick stainless steel inserts.

43. The arrangement of claim 37, further comprising a position sensor that participates in stopping the driving arm in a position whereby a branch of the driving arm is located in a high position of the tipping fixed bowl to thereby facilitate the discharge of the dough when the tipping bowl is tipped.

44. The arrangement of claim 37, wherein the brake comprises a knob, an inclined threaded shaft passing through a bushing, and a lining holder adapted to press on a hub fixed to a shaft of the freely rotating counter-arm.

45. The arrangement of claim 37, further comprising a tipping device for tipping the tipping bowl, wherein the tipping device comprises an inflated pneumatic wheel bearing on a wall of the tipping bowl.

46. The arrangement of claim 37, further comprising:
a liftable screen mounted to the tipping bowl;
a water inlet unit using hoses;
a flow sensor associated with a valve and nozzles and being connected to a display unit of a control box.

47. The arrangement of claim 37, further comprising a temperature probe connected to a display unit of a control box by a flexible wire positioned in a lower part a wall of the tipping bowl and on a control panel side of the tipping bowl.

48. The arrangement of claim 37, further comprising a programmable control box having the following modes:
a kneader mode;
a fermenter mode; and
a mode which utilizes rotation and stop cycles over time and a constant temperature.

49. The arrangement of claim 37, further comprising a bowl tipping device comprising a wheel for tipping the tipping bowl driven by a compact geared motor having a high reduction ratio, wherein the high reduction ration is either of a cycloid type or a planetary type and is incorporated in a frame.

50. The arrangement of claim 37, wherein the tipping bowl comprises stainless steel coated with a food-grade non-stick material.

51. The arrangement of claim 37, wherein the movable vat comprises a food-grade non-stick material and includes double walls filled with insulating foam.

52. The arrangement of claim 37, wherein the movable vat comprises:
a rectangular tubular chassis that reinforces and supports a discharge hatch adapted to allow forks of an elevator to be introduced therein; and
handles.

53. The arrangement of claim 37, further comprising an electrical distribution stacker adapted to elevate the movable vat.

54. The arrangement of claim 37, wherein the mixer kneader device further comprises:
side covers pivoted on hinges;
an electrical control box and a frequency-based speed controller associated with one of the side covers; and
a safety sensor associated with another of the side covers.

55. The arrangement of claim 37, wherein the movable vat comprises a discharge hatch movable via a handwheel.

56. The arrangement of claim 37, the device configured to elevate the mixer kneader device above the hopper comprises a sliding hydraulic elevating table.

57. The arrangement of claim 37, wherein the transmission comprises a compact planetary reduction unit positioned directly on a shaft of the driving arm.

58. The arrangement of claim 37, further comprising a transmission and a speed controller associated with the counter-arm.

59. An air conditioning system with low air mixing for heating and cooling, wherein the system is associatable directly or indirectly with horizontal, oblique, or spiral fermenting kneaders provided with panels for programming and regulating kneading during bakers' working times and sourdough cycles during rest times, the system comprising:
an arrangement that creates and maintains an air temperature and a puff pastry dough temperature in a range of between twenty and twenty-six degrees Celsius during kneading, mixing, shaping and storing processes which correspond to a fast fermentation phase; and
an arrangement that creates and maintains an air temperature, the puff pastry dough temperature, and a sourdough temperature in a range of between nine to sixteen degrees Celsius to thereby allow a slow rising of the puff pastry dough and a production of sourdough in interaction with an operation of said fermenting kneaders which correspond to a second slow fermentation phase.

60. The system of claim 59, wherein the system comprises a heat pump and a compressor unit, and wherein air is supplied above a sealed flexible suspended ceiling in a network of ducts which can be equipped with hatches, and wherein hot or cold air is diffused at a periphery of the suspended ceiling.

61. The system of claim 59, further comprising distribution ducts, an air conditioning unit, and slow-rotating fans, wherein cold or hot air is diffused by the distribution ducts associated with the air conditioning unit and the slow-rotating fans.

62. The system of claim 59, wherein said fermenting kneaders comprise programmable control panels that utilize the following programs:
a mixing and kneading time program;
a mixing time and a temperature rise program;
a bowl tipping program;
a solenoid valve and water quantity display program; and
a sourdough production program.

63. A horizontal fermenting kneader device for breadmaking comprising:
a tipping bowl;
a powered arm;
a helically-shaped brakeable counter-arm driven by a dough stream; and
an air conditioning system.

64. The device of claim 63, wherein the air conditioning system comprises the system of claim 59.

65. The device of claim 63, further comprising a compact geared brake motor unit for tipping the tipping bowl, wherein the compact geared brake motor unit is of a cycloid type or a planetary type and utilizes rollers and a belt.

66. The device of claim 63, further comprising:
a water inlet associated with a solenoid valve;
a flow sensor; and
atomizing nozzles.

67. The device of claim 63, further comprising an electrical equipment box containing electrical components and a frequency-based speed controller arranged on a transmission side of the device and fixed to a side member.

68. An oblique and spiral fermenting kneader device for breadmaking comprising:
a kneading arm driven by a compact transmission unit;
the compact transmission unit being arranged a vertical support plate; and
the vertical support plate being pivotally connected to a hollow column.

69. The device of claim 68, wherein the device utilizes the air conditioning system of claim 59 and the hollow column is a square or rectangular hollow column.

70. The device of claim 68, wherein the hollow column includes bushings, a gas actuator, and an index pin for locking a head unit in the kneading position by fitting into a flange associated with a pivot member.

71. The device of claim 68, further comprising a rotating bowl driven by a roller coated with a flexible material which bears on an outer periphery of the rotating bowl, wherein the roller is driven by a compact cycloid or planetary geared motor.

72. An arrangement comprising:
a plurality of horizontal, oblique and spiral fermenting kneaders associated with an air conditioning system; and
a single geared motor unit driving kneading arms of said fermenting kneaders at a same speed via pulleys and toothed belts.

73. The arrangement of claim 72, wherein the air conditioning comprises the air conditioning system of claim 59.

74. The arrangement of claim 72, further comprising a single geared motor unit driving all bowls and counter-arms of said fermenting kneaders.

75. The arrangement of claim 74, wherein the single geared motor unit driving all bowls and counter-arms is arranged within a tubular beam.

76. The arrangement of claim 72, wherein the single geared motor unit is arranged within a tubular beam.

77. The arrangement of claim 76, wherein the tubular beam is capable of being lifted and is movable via a gas actuator.
